(19) United States
(12) Patent Application Publication
(10) Pub. No.: US 2008/0215999 A1
(43) Pub. Date: Sep. 4, 2008

(54) Method and Mobile Telecommunication Terminal for Customizing User Interface

(75) Inventors: Jongbae Kim, Seoul (KR); Hoojong Kim, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 11/913,078

(22) PCT Filed: Aug. 31, 2006
(86) PCT No.: PCT/KR2006/003462

§ 371 Date: Oct. 30, 2007

(30) Foreign Application Priority Data
Aug. 31, 2005 (KR) 10-2005-0080854

(51) Int. Cl. G06F 3/048

(52) U.S. Cl. 715/762

(57) ABSTRACT

Disclosed is a method for customizing a user interface, wherein a user optionally sets a user interface displayed on a display unit of a mobile telecommunication terminal according to the user's tastes, such that a background screen image selectable by a user, which constitutes the user interface, is placed as a backdrop, and a menu image is overlapped on the background screen image in a transparent or semi-transparent double structure.

### TECHNICAL FIELD

The present invention relates to a mobile telecommunication terminal and a method for customizing a user interface. More particularly, the present invention relates to a mobile telecommunication terminal and a method for customizing a user interface, wherein a user sets a user interface displayed on a display unit of a mobile telecommunication terminal in various ways according to the user's tastes, such that a background screen image freely selectable by a user is placed as a backdrop, and a menu image is overlapped on the background screen image in a transparent or semi-transparent double structure.

### BACKGROUND ART

Information and telecommunication technology, representatives of which include the Internet and mobile telecommunication, have changed people's life patterns in modern times. As personal computers accessible to the Internet have come into wide use in almost all homes, schools and offices, acquisition of information using web sites, purchase of goods through electronic commerce, correspondence by E-mail, and the like have become common. Just a few years ago, people could use only the mobile telecommunication services mainly for voice communication with their mobile telecommunication terminals. However, even in mobile telecommunication terminals, wireless internet services provided with data communication services using the Internet have recently appeared.

Thus, according to development of mobile telecommunication services, the mobile telecommunication terminals have also been developed into mobile telecommunication terminals provided with various functions of camcorders, cameras, MP3 players and the like, beyond the initial concept of mobile phones having voice communication as a main service. While a variety of functions are added to the mobile telecommunication terminals, display devices thereof have also been developed from black and white display devices to color display devices. In general, the display devices of mobile telecommunication terminals function to inform users of information of various statuses, such as information of a power source, the reception strength of electric waves, the date, time and the like.

With the development in information and telecommunication technology, there have been wide spread of mobile telecommunication terminals with color display devices and wide use of wireless internet services, which caused appearance of various content-providing businesses. Particularly, a content providing business for providing still images and/or moving images to mobile telecommunication terminals in the course of waiting for communication, i.e., color-ring services have recently been highlighted. A user interface displayed on a mobile telecommunication terminal includes a background screen image and a menu image. In the conventional color-ring services, since a background screen image and a menu image are collectively set and displayed with a still image and/or a moving image provided by a content provider when a user uses a color-ring service, the user cannot configure the background screen image and the menu image in various ways in accordance with the user's taste.

### DISCLOSURE OF THE INVENTION

Therefore, the present invention has been made in view of the above-mentioned problems, and it is an object of the present invention to provide a mobile telecommunication terminal and a method for customizing a user interface, wherein a user sets a user interface displayed on a display unit of a mobile telecommunication terminal in various ways according to the user's tastes, such that a background screen image freely selectable by a user is placed as a backdrop, and a menu image is overlapped on the background screen image in a transparent or semi-transparent double structure.

According to one aspect of the present invention, there is provided a method for customizing a user interface, wherein a user optionally sets a user interface displayed on a display unit of a mobile telecommunication terminal according to the user's tastes, such that a background screen image selectable by a user, which constitutes the user interface, is placed as a backdrop, and a menu image is overlapped on the background screen image in a transparent or semi-transparent double structure, the method comprising the steps of: (a) receiving a request for driving of an interface manager that corresponds to an application used for customizing the configuration of the user interface; (b) loading the user interface that is currently displayed, and setting the user interface as an original user interface; (c) receiving a request for selection of a customized background screen image for the background screen image to be customized; and (d) producing a final user interface as the user interface of which the configuration has been customized, and displaying the final user interface on the display unit.

According to another aspect of the present invention, there is provided a mobile telecommunication terminal for customizing a user interface, wherein a background screen image freely selectable by a user, which constitutes the user interface, is placed as a backdrop, and a menu image is overlapped on the background screen image in a transparent or semi-transparent double structure, the mobile telecommunication terminal comprising: a key input unit provided with buttons for inputting characters and menu selection buttons for driving an interface manager which is an application capable of customizing the configuration of the user interface; a display unit for displaying an operational state of the mobile telecommunication terminal, including use state of a power source, reception strength of electromagnetic waves and time and the like, and for displaying the user interface produced through the interface manager; a program storage unit having a real time operating system, mobile telecommunication terminal call processing software and the interface manager embedded therein; a mode status storage unit for storing current operational mode of the mobile telecommunication terminal as a status flag, the operational mode being selected by the key input unit; a microprocessor for controlling the process of performing a general control of voice transmission/reception and data transmission/reception, producing the user interface of which setting is customized through the use of the user interface manager, and displaying the user interface on the user display unit; and a digital signal processor for coding and decoding voice signals, eliminating multi-path noise, and performing a sound data processing function and a decoding function for still images and/or moving images used for the interface manager.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram briefly illustrating an internal configuration of a mobile telecommunication terminal for customizing a user interface according to a preferred embodiment of the present invention;

FIG. 2 is a view illustrating a structure of a WIPI platform applied to the mobile telecommunication terminal usable for a Theme Pack Service according to the preferred embodiment of the present invention;

FIG. 3 is a flowchart illustrating a process of customizing a user interface according to the preferred embodiment of the present invention; and

FIGS. 4A to 4C illustrate exemplary screens of the mobile telecommunication terminal for customizing the display of a user interface according to the preferred embodiment of the present invention.

### MODE FOR CARRYING OUT THE INVENTION

Hereinafter, preferred embodiments of the present invention will be described with reference to the accompanying drawings. In the following description and drawings, the same reference numerals are used to designate the same or similar components, and so repetition of the description on the same or similar components will be omitted.

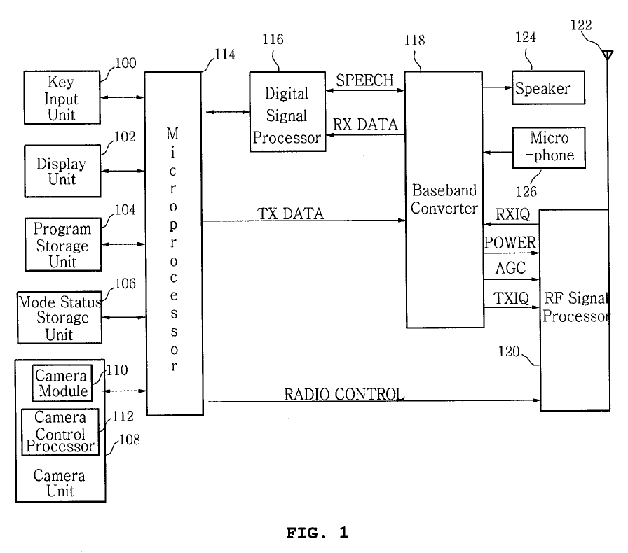

FIG. 1 is a block diagram briefly illustrating an internal configuration of a mobile telecommunication terminal for customizing a user interface according to a preferred embodiment of the present invention.

The inventive configuration of the mobile telecommunication terminal for customizing a user interface includes a key input unit 100, a display unit 102, a program storage unit 104, a mode status storage unit 106, a camera unit 108, a microprocessor 114, a digital signal processor 116, a baseband converter 118, an RF signal processor 120, an antenna 122, a speaker 124 and a microphone 126.

The present invention has a main feature in that, in a user interface displayed on the display unit 102 of the mobile telecommunication terminal, a user can select a background screen image in various image according to the user's tastes, the selected background screen image is placed as a backdrop, and a menu image is overlapped on the background screen image such that an overlapping portion, i.e., a portion at which the background screen image and the menu image overlap with each other, can be transparently or semi-transparently displayed.

In other words, there is a main feature in that, even when a user changes a background screen image in accordance with the user's tastes, the menu image is not changed, while the changed background screen image is placed as a backdrop and the menu image is overlapped on the background screen image such that the overlapping portion can be transparently or semi-transparently displayed. It will be apparent that a background screen image is not changed while only a menu image may be changed to be displayed. Here, mobile telecommunication services, in which, if a user selects a background screen image, the selected background screen image is placed as a backdrop, and a menu image is overlapped on the background screen image such that the overlapping portion can be transparently or semi-transparently displayed, is defined so-called as “Theme Pack Service”.

The key input unit 100 is provided with menu selection buttons necessary for use of the Theme Pack Service, as well as buttons for input of characters, including numeral keys for input of numerals such as telephone numbers. Further, the key input unit 100 is provided with special keys for driving the camera unit 108 in order to photograph a subject. According to the present invention, a user can obtain a still image and/or a moving image by driving the camera unit 108 through operation of the key input unit 100 provided to the mobile telecommunication terminal, and then specify the obtained image as a background screen image and/or menu image required in using the Theme Pack Service.

The display unit 102 displays an operation state of the mobile telecommunication terminal, including the state of a power source, the reception strength of electric waves, the date, time and the like, and displays a background screen image and a menu image using a menu item for a Theme Pack Service setting and the Theme Pack Service such that a portion at which the background screen image and the menu image overlap with each other can be transparently or semi-transparently displayed.

The program storage unit 104 includes an Electrically Erasable Programmable Read Only Memory (EEPROM), a flash memory, a Random Access Memory and the like. In the flash memory, a real time operating system, mobile telecommunication terminal call processing S/W, an interface manager and the like are stored. The software stored in the flash memory is driven after being loaded into the RAM. Here, the interface manager refers to software for controlling a function of processing a procedure related to the subscription and registration of the Theme Pack Service, a function of performing data call setup during voice call processing, an operation of selecting a background screen image, placing the selected background screen image as a backdrop, and then overlapping a menu image on the background screen image so as to transparently or semi-transparently display the overlapping portion in the course of using the Theme Pack Service. The interface manager may be either downloaded from a content-providing server (not shown) for providing the Theme Pack Service, or preliminarily embedded in a mobile telecommunication terminal at the time point when the mobile telecommunication terminal is released from a manufacturer, or the like.

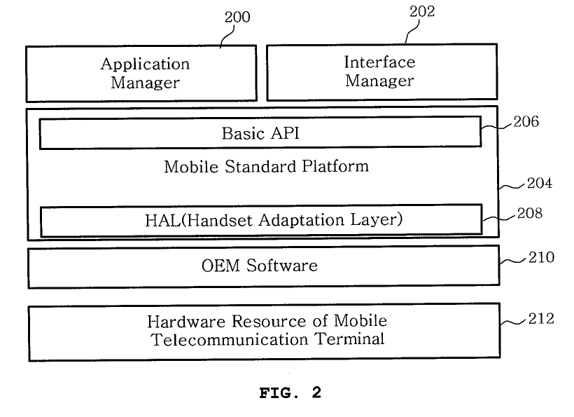

Further, the interface manager is developed/provided as e.g. a Wireless Internet Platform for Interoperability (WIPI) application. The interface manager embedded into the mobile telecommunication terminal, according to the embodiment of the present invention, will be described hereinafter in detail with reference to the structure of a WIPI platform shown in FIG. 2. Further, the program storage unit 104 has still images and/or moving images stored therein which are to be used for the Theme Pack Service.

The mode status storage unit 106 stores the current operation mode of the mobile telecommunication terminal, which is selected through the key input unit 100, as a status flag (e.g., 0, 1, 2, . . . ). That is, in order to discriminate among a standby mode, a transmission mode, a search mode, a communication mode, a general incoming call mode, a Theme Pack Service mode and the like of the mobile telecommunication terminal, the microprocessor 114 assigns a specific status flag to each of the modes to update the mode status storage unit 106.

The camera unit 108 includes a camera module 110 for producing a still image and/or a moving image to be provided as a background screen image and/or a menu image in the course of using the Theme Pack Service, and a camera control processor 112 for controlling the operation of the camera module.

The camera module 110 includes a Charge Coupled Device (CCD) or Complementary Metal Oxide Semiconductor (CMOS) type photographing device. The Camera Control Processor (CCP) 112 is a kind of central processing unit, and controls the general operation of the of the camera module 110, e.g., a zoom function, a flash function, and a function of photographing still images, moving images, and the like.

The microprocessor 114 controls the general operation procedures related to voice transmission/reception and data transmission/reception performed in the mobile communication terminal. Further, the microprocessor 114 drives the interface manager stored in the program storage unit 104 so as to control it to perform operations of registration, correction, deletion, edition and the like for various kinds of still images and/or moving images, used for the Theme Pack Service, and performs the function of overlapping a menu image on a background screen image so as to transparently or semi-transparently display the overlapping portion.

The Digital Signal Processor (DSP) 116 performs coding or decoding voice signals and eliminates multi-path noise, and refers to a digital signal processor for performing a sound data processing function, a decoding function for the Theme Pack Service, and the like. Further, the digital signal processor 116 transmits and receives speech data with the baseband converter 118, and receives digital data (RX data) including background screen images and menu images, which are input from the baseband converter 118.

The baseband converter 118 converts signals transmitted/received among the RF signal processor 120, the digital signal processor 116, the speaker 124 and the microphone 126 into base band signals, and performs the functions of Digital to Analog Conversion (DAC), Analog to Digital Conversion (ADC), and the like. The baseband converter 118 transmits transmission data (TXIQ) to the RF signal processor 120, and controls the electric power of the RF signal processor 120 or automatically controls the gain thereof. Further, the baseband converter 118 receives a reception signal (RFIQ) transmitted from the RF signal processor 120.

The RF signal processor 120 demodulates and amplifies RF signals received from the antenna 122, and modulates transmission signals applied from the baseband converter 118 to transmit them into a propagation space. The speaker 124 outputs sound data transmitted from the baseband converter 118 as audible sounds, and the microphone 126 converts a user's speech input into electric signals.

Meanwhile, the mobile telecommunication terminal according to the embodiment of the present invention includes a Personal Digital Assistant (PDA), a cellular phone, a Personal Communication Service (PCS) phone, a Global System for Mobile communication (GSM) phone, a Wideband CDMA (W-CDMA) phone, a CDMA-2000 phone, a Mobile Broadband System phone, or the like. Here, the MBS phone refers to a handheld phone to be used in the fourth-generation system that has been currently discussed.

FIG. 2 is a view showing a structure of a WIPI platform applied to the mobile telecommunication terminal usable for the Theme Pack Service according to the preferred embodiment of the present invention.

The structure of the WIPI platform applied to the mobile telecommunication terminal provided for the Theme Pack Service, according to the preferred embodiment of the present invention, includes an application manager 200, an interface manager 202, a mobile standard platform 204, OEM software 210 and a hardware resource 212 of a mobile telecommunication terminal.

The application manager 200 corresponds to a software module for performing the function of downloading the interface manager 202, which is a software package required in using the Theme Pack Service, from a content providing server, the function of installing the downloaded interface manager 202, the function of deleting the installed interface manager 202, and the like. When it is necessary to update an Application Programming Interface (API) and other components, which constitute the interface manager 202, the application manager 200 performs the function of addition, update or the like for a required software module.

The interface manager 202 refers to a software module in which a background screen image selected by a user is placed as a backdrop, and a menu image is overlapped on the background screen image such that an overlapping portion can be transparently or semi-transparently displayed. That is, the user drives the interface manager 202 by operating the key input unit 100 provided to the mobile telecommunication terminal in order to use the Theme Pack Service. The driven interface manager 202 separates the background screen image and the menu image from each other, which are displayed on the display unit 102, and temporarily stores the separated background screen image and menu image in a virtual area of the program storage unit 104. Thereafter, if the user selects a still image and/or a moving image to be used as the background screen image, the interface manager 202 temporarily stores the selected background screen image in the virtual area of the program storage unit 104, and loads the menu image, which has been previously separated and temporarily stored, from the program storage unit 104. Then, the interface manager 202 places the background screen image stored in the program storage unit 104 as a backdrop, and overlaps the menu image on the background screen image such that an overlapping portion can be transparently or semi-transparently displayed on the display unit 102. Here, the interface manager places the newly placed background screen image and menu image as one package to store it in the program storage unit 104.

The mobile standard platform 204 includes a basic API 206, a Handset Adaptation Layer (HAL) 208, and the like. Further, the mobile standard platform 204 means a software module for monitoring the present status of the hardware resource 212 of a mobile telecommunication terminal, controlling the use of the hardware resource 212 of a mobile telecommunication terminal in process of executing an application, and supporting various applications to be executed and transplanted regardless of a kind of real-time processing operating system embedded into the mobile telecommunication terminal.

The basic API 206 refers to a software module used in communicating with system software such as a real-time processing operating system or a database managing system in process of driving an application like the interface manager 202 according to the embodiment of the present invention. The basic API 206 is implemented to call a function for providing a connection to a specific subroutine of the real-time processing operating system embedded into the mobile telecommunication terminal.

The HAL 208 supports a platform standard for a terminal manufacturer, and means a software module for mutually interfacing between the hardware resource 212 of a mobile telecommunication terminal and the real-time processing operating system. That is, the HAL 208 provides an environment in which the application manager 202 can be driven in mobile telecommunication terminals with different hardware configurations for every manufacturers.

The OEM software 210 performs a basic speech call processing function, a sub-layer data communication function, a character message transmission/reception function, a mobile telecommunication terminal management function, and the like. If the OEM software 210 receives a control authentication for the application manager 202 from the mobile standard platform 204 and then receives a background screen image and a menu image provided from a content providing server, it controls the provided background screen image and menu image to be displayed on the display unit 102. Here, in order to achieve smooth operation of the interface manager 202 in the mobile telecommunication terminal, the OEM software 210 has SDV, which is a CDMA Rel.A standard, ported therein.

The hardware resource 212 of a mobile telecommunication terminal refers to a set of electronic/mechanical devices such as the key input 100, the display unit 102, the program storage unit 104 and the microprocessor 114 of the mobile telecommunication terminal.

That is, the mobile standard platform 204 controls the application manager 200 to install the interface manager 202 into the program storage unit 104, drives the installed interface manager 202 to select a background screen image, places the selected background screen image as a backdrop, and overlaps a menu image on the background screen image such that the overlapping portion can be transparently or semi-transparently displayed.

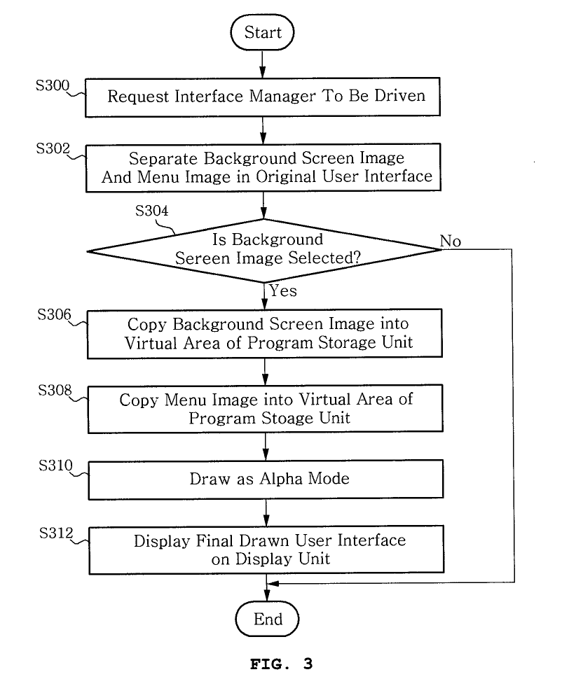

FIG. 3 is a flowchart illustrating a process of customizing a user interface according to the preferred embodiment of the present invention.

For convenience of illustration in the following processes, a user interface having been displayed on the display unit 202 before driving the interface manager 202 is defined as an ‘original user interface’, and a background screen image and a menu image, which constitute the original user interface, are defined as an ‘original background screen image’ and an ‘original menu image’, respectively. Further, a background screen image and a menu image, which a user intends to customize by driving the interface manager 202, are defined as a ‘customized background screen image’ and a ‘customized menu image,’ respectively. Furthermore, a user interface customized by the user is defined as a ‘final user interface,’ and a background screen image and a menu image, which constitute the final user interface, are defined as a ‘final background screen image’ and a ‘final menu image,’ respectively. In addition, an operation of overlapping a menu image on a background screen image such that an overlapping portion can be transparently or semi-transparently displayed, is defined as an ‘alpha mode’ for convenience of illustration in the following processes.

If a user operates the key input unit 100 to request the interface manager to be driven (S300), a mobile telecommunication terminal starts using a Theme Pack Service. The interface manager loads an original user interface displayed on the display unit 102, and individually separates a background screen image and a menu image, which constitute the original user interface, to produce an original background screen image and an original menu image (S302).

Thereafter, the user operates the key input unit 100 to select a still image and/or a moving image stored in the program storage unit 104, and selects a customized background screen image as a background screen image intended to be customized (S304). Here, the user may use a still image and or moving images generated by driving the camera unit 108 provided to the mobile telecommunication terminal as the customized background screen image, or use a still image and or moving images downloaded from a content-providing server as the customized background screen image.

If the user selects the customized background screen image in step S304, the interface manager 202 temporarily stores the selected customized background screen image in a virtual area of the program storage unit 104 (S306). The interface manager 202 loads the separated original menu image into a virtual area of the program storage unit 104 to temporarily store it (S308). Here, the size of the virtual area, in which the customized background screen image is temporarily stored, is maintained to be equal to the size of the virtual area, in which the original menu image is temporarily stored.

The interface manager 202 draws the customized background screen image and the original menu image through an alpha mode (S310). Thereafter, the interface manager 202 configures the drawn customized background screen image and original menu image as a final user interface to store it in the program storage unit 104, and displays the final user interface on the display unit 102.

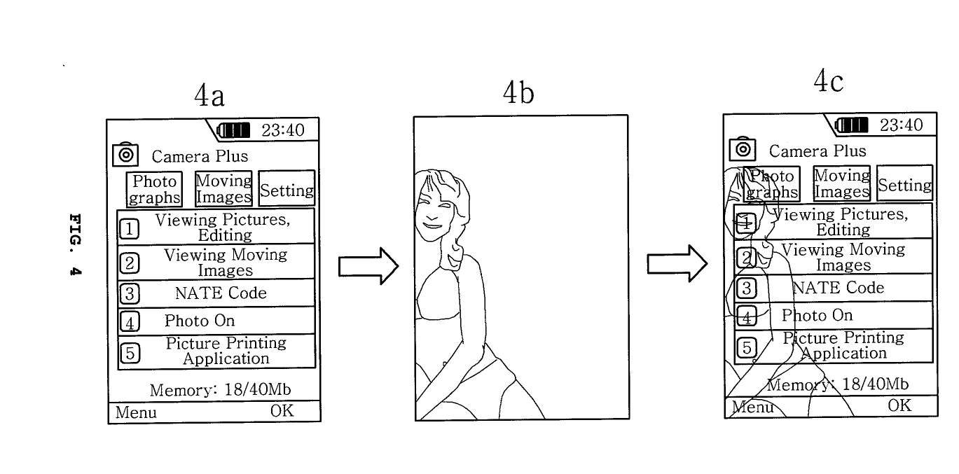

FIGS. 4A to 4C are exemplary screens of the mobile telecommunication terminal for customizing the display of a user interface according to the preferred embodiment of the present invention.

If a user operates the key input unit 100 to drive the interface manager, the driven interface manager individually separates an original user interface into an original background screen image and an original menu image. FIG. 4A is a view showing the separated original menu image.

Thereafter, the user selects a still image and/or a moving image, which are stored in the program storage unit 104, so as to select a customized background screen image as shown in FIG. 4B. The interface manager 202 overlaps the original menu image shown in FIG. 4A on the customized background screen image shown in FIG. 4B to produce a final user interface as shown in FIG. 4C, and displays the final user interface on the display unit 104. Here, the interface manager draws portions, at which the customized background image and the original menu image overlap with each other, through the alpha mode.

### INDUSTRIAL APPLICABILITY

As described above, according to the present invention, there is an advantage in that a user can select a background screen image displayed on a mobile telecommunication terminal in accordance with the user's tastes, and a menu image is overlapped on the background screen image such that an overlapping portion can be transparently or semi-transparently displayed, so that trendy users who desire to show their unique personalities can have a far better appearance.

Further, since mobile telecommunication providers provide services more distinguished than their competitors in a case of mobile telecommunication businesses of which success or failure depends on the security of mobile telecommunication subscribers, there is an advantage in that they can be in a better position in wining over mobile telecommunication subscribers.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method for customizing a user interface, wherein a user optionally sets a user interface displayed on a display unit of a mobile telecommunication terminal according to the user's tastes, such that a background screen image selectable by a user, which constitutes the user interface, is placed as a backdrop, and a menu image is overlapped on the background screen image in a transparent or semi-transparent double structure, the method comprising the steps of:
(a) receiving a request for driving of an interface manager that corresponds to an application used for customizing the configuration of the user interface;
(b) loading the user interface that is currently displayed, and setting the user interface as an original user interface;
(c) receiving a request for selection of a customized background screen image for the background screen image to be customized; and
(d) producing a final user interface as the user interface of which the configuration has been customized, and displaying the final user interface on the display unit,
wherein step (b) includes the sub-steps of:
(b1) separating an original background screen image from an original menu image, both of which constitute the original user interface;
(b2) storing the original background screen image in a virtual area in a program storage unit in which data to be displayed on the display unit are temporarily stored; and
(b3) storing the original menu image in another area having a size equal to a size of the virtual area in which the original background screen image is stored
wherein step (d) includes the sub-steps of:
(d1) setting the customized background screen image selected in step (c) as the backdrop;
(d2) overlapping the original menu image separated in step (b) on the customized background screen image; and
(d3) processing portions at which the customized background image and the original menu image overlap with each other to be transparent or semi-transparent.

2. (canceled)

3. The method according to claim 1, wherein step (c) includes the sub-steps of:
(c1) providing still images and/or moving images, which are produced by using a camera unit of the mobile telecommunication terminal, as the customized background screen image; and
(c2) providing the still images and/or the moving images as the customized background screen image which are downloaded through wireless internet services.

4. (canceled)

5. The method according to claim 1, wherein the final user interface is produced while fixing the background screen image and selecting the menu image.

6. A mobile telecommunication terminal for customizing a user interface, wherein a background screen image freely selectable by a user, which constitutes the user interface, is placed as a backdrop, and a menu image is overlapped on the background screen image in a transparent or semi-transparent double structure, the mobile telecommunication terminal comprising:
a key input unit provided with buttons for inputting characters and menu selection buttons for driving an interface manager which is an application capable of customizing the configuration of the user interface;
a display unit for displaying an operational state of the mobile telecommunication terminal, including use state of a power source, reception strength of electromagnetic waves and time and the like, and for displaying the user interface produced through the interface manager;
a program storage unit having a real time operating system, mobile telecommunication terminal call processing software and the interface manager embedded therein;
a mode status storage unit for storing current operational mode of the mobile telecommunication terminal as a status flag, the operational mode being selected by the key input unit;
a microprocessor for controlling the process of performing a general control of voice transmission/reception and data transmission/reception, producing the user interface of which setting is customized through the use of the user interface manager, and displaying the user interface on the user display unit; and
a digital signal processor for coding and decoding voice signals, eliminating multi-path noise, and performing a sound data processing function and a decoding function for still images and/or moving images used for the interface manager,
wherein the interface manager separates the background screen image and the menu image respectively into an original background screen image and an original menu image in the user interface being currently displayed, selects a customized background screen image as the background screen image intended to be customized, and produces a final user interface by overlapping the original menu image on the selected customized background screen image such that an overlapping portion can be transparently or semi-transparently displayed.

7. (canceled)

8. The mobile telecommunication terminal according to claim 6, wherein the mobile telecommunication terminal uses the background screen image as a still image and/or a moving image, which are produced through a provided camera unit or downloaded through wireless internet services.
